(19) United States
(12) Patent Application Publication
(10) Pub. No.: US 2009/0152861 A1
(43) Pub. Date: Jun. 18, 2009

(54) SECURITY LABEL SET AND USE

(75) Inventors: Tobias Kresse, Hamburg (DE); Volker Hahn, Hamburg (DE); Christoph Dietrich, Heidelberg (DE)

Correspondence Address: NORRIS, MCLAUGHLIN & MARCUS, 875 THIRD AVE, 18TH FLOOR, NEW YORK, NY, 10022, US

(73) Assignee: TESA SCRIBOS GMBH, Heidelberg (DE)

(21) Appl. No.: 12/271,447

(22) Filed: Nov. 14, 2008

(30) Foreign Application Priority Data
Dec. 18, 2007 (DE) 20 2007017 753.4

(51) Int. Cl. G09F 3/00

(52) U.S. Cl. 283/81

(57) ABSTRACT

A security label set comprising security labels, a backing material common to the security label, wherein the at least one security label is arranged directly on the common backing material and the other security label is indirectly arranged on the common backing material by being arranged to the backing. The security labels may be releasably arranged on the backing. The security labels are individualized by including serial or random numbers o by a computer-generated hologram. The backing may be in form of a web-form liner.

### BACKGROUND OF THE INVENTION

(1) Field of the Invention

The invention relates to security label sets having at least two security labels, in accordance with the preamble of claim 1, and to their use for anti-counterfeiting and/or proof of originality and/or grey market tracking of objects of any kind.

Evermore frequently nowadays, producers of a wide variety of different products are being confronted by the situation that their products are copied or counterfeited. Counterfeited products represent to the producer not only an economic loss, in some cases considerable. Rather, in the case of unrecognized copies of poorer quality, there may be failure in operation and hence loss of regard for the brand, or even accidents. Imitation products with faulty components or incorrect ingredients may therefore represent a danger to life and limb. Accordingly there is great interest on the part of producers in marking original products with regard to their originality. In this way a customer can be informed that he or she is getting the product actually desired, as an original, and hence in the expected quality.

A further problem for producers is the grey market trade. This term is used to refer to the trade with original articles via unintended distribution channels. Here again, the producer may suffer considerable economic damage. Suitable security features, such as serial numbers and controls thereon, allow the producer to identify products at the unit level. The producer can then examine whether a product is reaching the customer via the intended distribution channel, or is in the intended distribution channel, and so can discover and prevent grey market trade.

A particularly suitable way of marking the products for proof of originality or for combating the grey market are security labels. A range of different security features have been proposed that may be part of such security labels and are intended to protect the products, and also the security labels themselves, against copying. Examples of those known in this context include a) printing operations for producing particular features, where appropriate using what are called security inks or security printing inks, b) electronic markers (e.g. radio-frequency identification—RFID), c) holographic features, d) doping with what are called taggants (chemical or physical markers) or e) special security numbers. It has been found to be very advantageous to individualize the security labels, in other words to give them, for example, a serial number. Via the unambiguous serial number located on the security label, the marked product can then be identified and distinguished from products of the same construction or same kind.

Products are often sold not as they are but instead as part of a pack. If the product carries a security feature, it is frequently not possible in these cases to inspect it for originality without first opening the pack. This is usually undesirable, since a pack that has already been opened may possibly no longer be saleable. If, on the other hand, the pack is given a security label, then an authenticity inspection is possible prior to sale, but not after sale, if the pack has been recycled. In this case there is a desire to apply the proof of originality, in the form of a security label, not only into or onto the product, but also onto the pack. As a result of this, there is a need to assign two or possibly even more security labels to a product that is to be secured, and to carry out this assignment in such a way that the product and/or at least one further object in the vicinity of the product, such as a pack, for example, can be easily and completely marked with security labels at the intended positions.

(2) Description of Related Art

Known from the art, in particular in motor vehicle construction, are security label sets in the form of plate sets, which are used to mark two or more components of a motor vehicle. Plate sets of this kind are supplied as an inscribed roll product, comprising laser-markable film, to the motor vehicle manufacturer, where they are processed into an individual plate set consisting of two or more security labels. The problem on which the present invention is based is that of specifying a security label set optimized in terms of handling and diverse possibilities for use.

### BRIEF SUMMARY OF THE INVENTION

This object is achieved for a security label set having the features of the preamble of claim 1 through the features of the characterizing clause of claim 1. Additional solutions are described by the security label sets according to claims 7 and 8 and also by a security label set system according to claim 15. Preferred embodiments and developments are subject matter of the respective dependent claims.

The security label set of the invention comprises at least two security labels. These labels are arranged directly or indirectly on a common backing. Indirectly in this context means that between the respective security label and the backing there a further layers arranged, an additional film, for example, whereas in the case of direct arrangement on the backing there are no layers between the security label and the backing. This common arrangement of the security labels ensures ease of handling, since in this way the sets can be provided as a whole and the security labels can be applied as desired, without a risk of individual security labels being lost or mixed up. Furthermore, the security labels on the backing are arranged on different substrates. This arrangement entails a high level of complexity as compared with the provision of unchanging roll product, but offers the advantage that the security labels can be adapted to any of a very wide variety of requirements, in respect for example of number of security labels desired, permanent dwelling on the backing, adaptation to the base in the case of application, by means of different adhesives, etc. Furthermore, the customer does not have to process the security labels itself and is therefore freed from the ballast that is produced as a result of trimming in the case of roll material.

Security labels which can be employed for the purposes of this invention include, without restriction, all kinds of security labels known to the skilled person. Security labels which can be employed carry open and/or hidden security features. These features may take the form more particularly of imprints, Microtexts and micro-graphics or else guilloche patterns can be employed, for example, as can inks which alter their appearance according to external influence or angle of viewing, including, for example, what are known as flop inks. It is also possible to provide the security labels with taggants. Safety labels which can be employed may, moreover, have embossed structures, more particularly holographic structures. It is possible, furthermore, to provide electronic codes (e.g. RFID) in the security labels. Security labels of security label sets of the invention very preferably contain structures introduced by means of laser methods, and more particularly structures of holographic kind. Suitable for use with particular advantage in the inventive sense as a security feature is the feature marketed as tesa Holospot®. This is a computer-generated hologram which is calculated for each individual unit and written into the security label by means of a laser lithography method. Any desired combinations of the aforementioned security features, or of further security features known to the skilled person, can be used on security labels in the sense of this invention.

In a co-independent embodiment, the security labels of one security label set are arranged on a card, more particularly a plastic card. An embodiment of this kind has the advantage over the known roll product that the label set remains together, with security against being lost, even after the actual inscription and shaping of the labels. Moreover, as a result of the embodying of the backing as a card, the risk of unintended parting is reduced. Unintended parting from a backing generally begins with a crease in the backing material, i.e., typically a film. Since in this case it is a card, and hence a relatively rigid material, that is used as the carrier, the carrier is protected against creases and hence the security labels are protected against detachment at such creases.

In a further co-independent embodiment, at least two of the security labels on their underside have adhesive layers with different adhesives. As a result, this security label set allows the security labels to be adapted to different fields of use, such as a bond to the cardboard of a pack and a bond to the product itself, for example, such as to plastic, metal, leather or the like, for example. The adhesive layers may therefore be adapted to a particular bond substrate and can therefore apply the required bond strength and durability. Such adaptation is not possible in the case more particularly of security label sets comprising roll product.

In a preferred embodiment the security labels preferably have a serial number. Within the security label set, the serial numbers between the individual security labels are advantageously correlated with one another. They may, for example, be identical or partially identical, or may differ from one another in a specific running value, generally one or more alphanumeric symbols, while other, additional features may be the same on all of the security labels of the same security label set. The security labels within a security label set may, moreover, include a feature which indicates the fact that they belong to that particular security label set, but which differs from security labels of other security label sets.

The serial numbers which the security labels preferably include may be applied or introduced by means of any method known to a person skilled in the art. Appropriate methods include, for example, embossing, inkjet methods, thermal transfer methods and laser-based methods, more particularly laser lithography methods. The security label material is preferably provided such that it is highly compatible with the inscribing process that is envisaged. For a laser inscribing process, for example, laser-sensitive pigments can be added to the label material. Alternatively there may be special functional layers provided.

Serial numbers of any desired digit number and syntax may be employed in accordance with the invention. More particularly, those based on alphanumeric symbols are outstandingly suitable. The serial numbers may optionally be in a coded form. Common coding formats are barcodes, matrix codes and 2D codes. The coding may also be incorporated in electronic or magnetic form (e.g. as RFID). Other open or hidden coding formats can likewise be used advantageously.

Very preferably, the security labels within a security label set differ at least partly from one another, in particular in their serial numbers or parts thereof. Furthermore, it is advantageous if all of the security labels of the same security label set are the same in terms of at least one feature, more particularly at least in part of the serial number, whereas they differ at least partly in this feature from security labels in other security label sets.

The security labels preferably have at least one layer of a backing material in the form of a polymer film, a paper, a lacquer or a flat composite material. For producing a backing in the form of a polymer film it is possible in principle to use all film-forming and extrudable polymers. In one preferred version, polyolefins are used. Preferred polyolefins are prepared from ethylene, propylene, butylene and/or hexylene, it being possible in each case to polymerize the pure monomers, or mixtures of the stated monomers are copolymerized. Through the polymerization process and through the selection of the monomers it is possible to control the physical and mechanical properties of the polymer film, such as the softening temperature and/or the tensile strength, for example.

In a further preferred version of this invention, polyvinyl acetates are used. Polyvinyl acetates may contain not only vinyl acetate but also vinyl alcohol as a comonomer, and the free alcohol fraction can be varied within wide limits. In a further preferred version of this invention, polyesters are used as backing film. One particularly preferred version of this invention uses polyesters based on polyethylene terephthalate (PET). A further preferred version of this invention uses polyvinyl chlorides (PVC) as the film. To increase the temperature stability it is possible for the polymer constituents present in these films to be prepared using stiffening comonomers. Furthermore, the films may be radiation-crosslinked in the course of the inventive operation, in order to obtain such an improvement in properties. Where PVC is employed as the base material for the film, it may optionally comprise plasticizing components (plasticizers). In a further preferred version of this invention, polyamides are used for producing films. The polyamides may be composed of one dicarboxylic acid and one diamine or of two or more dicarboxylic acids and diamines. Besides dicarboxylic acids and diamines it is also possible to use carboxylic acids and amines of higher functionality in combination with the abovementioned dicarboxylic acids and diamines. To stiffen the film it is preferred to use cyclic, aromatic or heteroaromatic starting monomers. In one further preferred version of this invention, polymethacrylates are used to produce films. In this case it is possible to control the glass transition temperature of the film through the choice of the monomers (methacrylates and, in part, acrylates as well). Furthermore, the polymethacrylates may also comprise additives for—for example—increasing the film's flexibility or raising or lowering the glass transition temperature, or for minimizing the formation of crystalline segments. One further preferred version of this invention uses polycarbonates to produce films. Furthermore, in a further version of this invention, copolymers and copolymers based on vinyl aromatics and vinyl heteroaromatics may be used to produce the backing film. This listing makes no claim to completeness. Rather, the skilled person is aware of further materials or combinations of materials that may likewise be used with advantage in the sense of this invention.

To produce a material in film form it may also be appropriate here to add additives and further components which enhance the film-forming properties, reduce the tendency for crystalline segments to form, and/or specifically improve or else, where appropriate, impair the mechanical properties. It may be advantageous to select a brittle and/or easy-tear material as backing material for the security labels.

The security labels carry an adhesive agent preferably on at least one side. The adhesive agent is preferably a self-adhesive layer or a heat-sealable layer.

Where a self-adhesive layer is employed, it advantageously comprises a pressure-sensitive adhesive formulation. As pressure-sensitive adhesives (PSAs) it is possible in particular to employ all linear, star-shaped, branched, grafted or alternatively formed polymers, preferably homopolymers, random copolymers or block copolymers that have a molar mass of at least 100 000 g/mol, preferably of at least 250 000 g/mol, very preferably of at least 500 000 g/mol. Preference is also given to a softening temperature of less than 0° C., preferably of less than −30° C. The molar mass in this context is the weight average of the molar mass distribution as is obtainable, for example, via gel permeation chromatography analyses. By softening temperature in this context is meant the quasi-static glass transition temperature for amorphous systems, and the melting temperature for semi-crystalline systems, both of which can be determined, for example, by means of dynamic differential calorimetry measurements. Where numerical values are specified for softening temperatures, they relate in the case of amorphous systems to the midpoint temperature of the glass stage, and in the case of semi-crystalline systems to the temperature of maximum enthalpy change during the phase transition.

As pressure-sensitive adhesives it is possible to use any of the PSAs known to the skilled person, more particularly acrylate-, natural rubber-, synthetic rubber- or ethylene-vinyl acetate-based systems. Combinations of these systems as well can be used in accordance with the invention.

As examples, mention may be made, but without wishing to impose any restriction, as advantageous in the context of this invention, of random copolymers starting from nonfunctionalized α,β-unsaturated esters, and random copolymers starting from nonfunctionalized alkyl vinyl ethers. It is preferred to use α, β-unsaturated alkyl esters of the general structure

CH₂═CH(R¹)(COOR²) (I)

where R¹ is H or CH₃ and R² is H or linear, branched or cyclic, saturated or unsaturated alkyl radicals having 1 to 30, more particularly having 4 to 18, carbon atoms.

Monomers which are used very preferably in the sense of the general structure (I) encompass acrylic and methacrylic esters with alkyl groups consisting of 4 to 18 C atoms. Specific examples of such compounds, without wishing to impose any restriction by giving this enumeration, are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, their branched isomers, such as 2-ethylhexyl acrylate and isooctyl acrylate, for example, and also cyclic monomers such as cyclohexyl or norbornyl acrylate and isobornyl acrylate, for example.

As monomers it is likewise possible to employ acrylic and methacrylic esters which contain aromatic radicals, such as phenyl acrylate, benzyl acrylate, benzoin acrylate, phenyl methacrylate, benzyl methacrylate or benzoin methacrylate, for example.

Additionally it is possible optionally to use vinyl monomers from the following groups: vinyl esters, vinyl ethers, vinyl halides, vinylidene halides, and also vinyl compounds which contain aromatic rings or heterocycles in α position. For the vinyl monomers that are optionally employable, mention may be made, by way of example, of selected monomers that can be used in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile, styrene and α-methylstyrene.

Further monomers which can be used in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acrylic acid, methacrylic acid, itaconic acid and esters thereof, crotonic acid and esters thereof, maleic acid and esters thereof, fumaric acid and esters thereof, maleic anhydride, methacrylamide and also N-alkylated derivatives, acrylamide and also N-alkylated derivatives, N-methylolmethacrylamide, N-methylolacrylamide, vinyl alcohol, 2-hydroxyethyl vinyl ether, 3-hydroxypropyl vinyl ether and 4-hydroxybutyl vinyl ether.

In the case of rubber, or synthetic rubber, as starting material for the PSA, there are further possible variations, whether from the group of the natural rubbers or the synthetic rubbers, or whether comprising any desired blend of natural rubbers and/or synthetic rubbers, it being possible for the natural rubber or rubbers to be selected in principle from all available grades such as, for example, crepe, RSS, ADS, TSR or CV products, depending on the required level of purity and viscosity, and for the synthetic rubber or rubbers to be selected from the group of the randomly copolymerized styrene-butadiene rubbers (SBR), the butadiene rubbers (BR), the synthetic polyisoprenes (IR), the butyl rubbers (IIR), the halogenated butyl rubbers (XIIR), the acrylate rubbers (ACM), the ethylene-vinyl acetate copolymers (EVA) and the polyurethanes and/or blends thereof.

Additionally it is possible for rubbers to be admixed, in order to improve their processing properties, preferably with thermoplastic elastomers, with a weight fraction of 10% to 50% by weight, based on the total elastomer fraction. Representatives that may be mentioned at this point include in particular the especially compatible polystyrene-polyisoprene-polystyrene (SIS) and polystyrene-polybutadiene-polystyrene (SBS) products.

Likewise suitable for use with advantage as base materials for adhesive layers are block copolymers. In these copolymers, individual polymer blocks are linked covalently to one another. The linkage of the blocks may be present in a linear form, or else in a star-shaped or graft copolymer variant. One example of a block copolymer which can be used advantageously is a linear triblock copolymer whose two end blocks have a softening temperature of at least 40° C., preferably of at least 70° C., and whose middle block has a softening temperature of not more than 0° C., preferably of not more than −30° C. Higher block copolymers, such as tetrablock copolymers, can likewise be employed. It is important that at least two polymer blocks of the same or different type are present in the block copolymer which have a softening temperature in each case of at least 40° C., preferably of at least 70° C., and are separated from one another by at least one polymer block having a softening temperature of not more than 0° C., preferably of not more than −30° C., in the polymer chain. Examples of polymer blocks are polyethers such as polyethylene glycol, polypropylene glycol or polytetrahydrofuran, for example, polydienes, such as polybutadiene or polyisoprene, for example, hydrogenated polydienes, such as polyethylene-butylene or polyethylene-propylene, for example, polyesters, such as polyethylene terephthalate, polybutanediol adipate or polyhexanediol adipate, for example, polycarbonate, polycaprolactone, polymer blocks of vinylaromatic monomers, such as polystyrene or poly-α-methylstyrene, for example, polyalkyl vinyl ethers, polyvinyl acetate, polymer blocks of α,β-unsaturated esters such as, more particularly, acrylates or methacrylates. Corresponding softening temperatures are known to the person skilled in the art. Alternatively a skilled person looks them up in, for example, the Polymer Handbook [J. Brandrup, E. H. Immergut, E. A. Grulke (ed.), Polymer Handbook, 4th edn. 1999, Wiley, New York]. Polymer blocks may be composed of copolymers.

Tackifying resins which can be used optionally include without exception all known tackifier resins described in the literature. Representatives that may be mentioned are the rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to adjust the properties of the resulting adhesive in accordance with what is desired.

As plasticizers, which can likewise be used optionally, it is possible to use any of the plasticizing substances that are known from self-adhesive technology. They include, among others, the paraffinic and naphthenic oils, (functionalized) oligomers such as oligobutadienes and oligoisoprenes, liquid nitrile rubbers, liquid terpene resins, vegetable and animal fats and oils, phthalates and functionalized acrylates. Pressure-sensitive adhesives as indicated above may additionally comprise further constituents such as additives with rheological activity, catalysts, initiators, stabilizers, compatibilizers, coupling reagents, crosslinkers, antioxidants, other ageing inhibitors, light stabilizers, flame retardants, pigments, dyes, fillers and/or expandants, and also, optionally, solvents.

Where a heat-sealable layer of adhesive is employed in the security labels of the invention, the layer in question is preferably a heat-laminable layer of adhesive. This may be a layer based on a reactive adhesive. For the purposes of this invention, heat-sealing layers may be reactive or non-reactive.

Where a heat-activable reactive adhesive is employed in the at least one layer of adhesive, it preferably comprises a thermoplastic polymer with a fraction of 30% to 90% by weight, more particularly of about 50% by weight, and also one or more tackifying resins with a fraction of 10% to 70% by weight, more particularly of about 50% by weight, the resins being, more particularly, epoxy resins with curing agents, accelerators as well where appropriate, and/or phenolic resins.

The reactive adhesive is a mixture of reactive resins which crosslink at room temperature and form a three-dimensional polymer network of high strength, and of permanently elastic elastomers which counteract embrittlement of the layer of adhesive and hence permit durable stresses (compressions, extensions) of the product. The elastomer comes preferably from the group of polyolefins, polyesters, polyurethanes or polyamides, or may be a modified rubber, such as nitrile rubber, for example, or else polyvinyl butyral, polyvinyl formal, polyvinyl acetate, carboxylated or epoxylated styrene/diene triblock copolymer, it also being possible for the diene block to be partially or fully hydrogenated. Nitrile rubber is employed with very particular preference.

The preferred thermoplastic polyurethanes, which are reaction products of polyester polyols or polyether polyols and organic diisocyanates such as diphenylmethane diisocyanate, are known. They are composed of predominantly linear macromolecules. Such raw materials are mostly obtainable in the form of elastic granules commercially. By combining thermoplastic polyurethanes with selected compatible resins it is possible to lower the softening temperature sufficiently. In parallel with this there is even an increase in the adhesion. Examples of resins which have proved to be suitable include certain rosins, hydrocarbon resins and coumarone resins. Alternatively, the reduction in softening temperature can be achieved through the combination of thermoplastic polyurethanes with selected epoxy resins based on bisphenol A and/or F and a latent curing agent.

The chemical crosslinking reaction (on the basis of epoxides or phenolic resin condensation) of the resins at elevated temperature produces high strengths between the layer of reactive adhesive and the surface to be bonded. The addition of the reactive resin/curing agent systems also leads to a reduction in the softening temperature of the abovementioned polymers, which has the advantageous effect of lowering their processing temperature and processing rate. The reactive adhesive is self-adhesive at room temperature or slightly elevated temperatures. When the layer of reactive adhesive is heated, there is also, in the short term, a reduction in the viscosity, as a result of which the reactive adhesive is able to wet even rough surfaces.

The compositions of the reactive adhesive can be widely varied by changing the nature and proportion of base materials. It is also possible to obtain further properties in the product, such as colour, thermal or electrical conductivity, for example, by means of specific additions of dyes, mineral and/or organic fillers, silicon dioxide for example, and/or carbon powders and/or metal powders. Furthermore, for the same or a different purpose, it is possible to use optionally silverized glass beads, metallized particles and/or spacer particles. The skilled person is aware of further additions which can be used with advantage in the heat-activable reactive adhesive layers that can be used in accordance with the invention.

Non-reactive heat-sealing adhesives are based typically on thermoplastic materials such as polyolefins, polyurethanes or polyamides, for example. An overview of a selection of heat-sealing adhesives that can be used suitably for the purposes of this invention is given by C. W. Paul (C. W. Paul in “Adhesion Science and Engineering 2—Surfaces, Chemistry & Applications”, M. Chaudhury, A, V. Pocisu (ed.), Elsevier, Amsterdam, 2002).

There are no limitations in respect of the coating process of adhesive layers, whether they be self-adhesive or heat-sealable layers. Solvent-borne and solvent-free adhesives, and aqueous systems as well, are suitable for the purposes of this invention.

The nature of the adhesive agent employed in the adhesive layer of the security labels may vary among the security labels within one security label set The adhesive agent is adapted in accordance with the target substrate for the ultimate bonding of the individual security labels. Individual security labels within a security label set may be equipped, for example, with a heat-sealing adhesive. This is especially advantageous when a security label of the security label set is bonded or is to be bonded, for example, to a plastic card.

In one preferred embodiment at least one security label of the security label set is located on a liner material, in other words an intermediate carried, from which it can be detached in order to be adhered at a desired position in or on the product to be secured, or in the vicinity of that product, in other words, for example, on an associated pack or another object connected to the product. To produce a liner material which can be used in accordance with the invention it is possible, where the liner is a film-based liner, to use in principle all film-forming and extrudable polymers. The release film (liner) is composed of a carrier film which is equipped on one or both sides with a release lacquer, preferably based on silicone. The release lacquer may be coated or painted. In one preferred version of this invention, polyolefins are used as carrier material for the release film. Preferred polyolefins are prepared from ethylene, propylene, butylene and/or hexylene, it being possible in each case to polymerize the pure monomers, or mixtures of the stated monomers are copolymerized. Polyester-based film liners can likewise be employed with advantage. Polyesters based in particular on polyethylene terephthalate (PET) are outstandingly suitable carrier material for release liners.

Furthermore, various papers, optionally also in combination with a stabilizing extrusion coating, are suitable as carrier material for release materials. All of the stated release carriers obtain their anti-adhesive properties by means of one or more coating operations with, for example, a silicone-based release.

In a further embodiment the liner material, on the side opposite the release material, carries an adhesive, more particularly an adhesive which preferably can be detached substantially without residue or destruction from a bond substrate. In this preferred version, therefore, the adhesive is what is called a reversible adhesive. For the purposes of this invention, such material is called release label material. Reversible adhesives are known from commercial applications such as, for example, adhesive masking tapes, labels, sticky notes, plasters or protective films. The adhesive bonds in the sense of this invention are made on any of a very large variety of substrates, but more particularly on plastic, paper or composite materials. From these materials the adhesive layers, according to this preferred version of the invention, ought to be detachable substantially without residue or destruction.

As a result of the large number of commercial applications, a variety of routes have been taken in the past for producing reversible PSAs. These and other methods known to the skilled worker can also be used in the sense of the present invention. One possibility is the structuring of the PSA, where the reversibility is produced by reduction in the adhesive area, as described in WO 85/04602 A1 or in U.S. Pat. No. 4,587,152, for example. The latter uses a screen printing process for structuring. Further possibilities are given by U.S. Pat. No. 5,194,299, which teaches the production of adhesive islets via a spray technique, and by U.S. Pat. No. 6,123,890, which proposes generating a structure in the adhesive layer by means of an embossing process. Another example of reversibly adhesive products through structuring of the adhesive layer is disclosed in U.S. Pat. No. 4,889,234.

Besides structuring by means of coating/patterns, it is likewise possible to achieve a structure by means of targeted crosslinking and thus to achieve reversibility in a PSA. U.S. Pat. No. 4,599,265 describes acrylate PSAs which are crosslinked in a segmented manner. A further possibility is to carry out chemical modification of PSAs, with an attendant fall in bond strength. A chemical solution for this exists in pressure-sensitive adhesive tapes with grafted polysiloxane units, as is described in U.S. Pat. No. 4,693,935. Furthermore, it is known to create adhesive and non-adhesive domains in the PSA by using acrylate block copolymers, and so to generate reversible adhesive properties, as set out in EP 1 308 493 B1.

PSAs for reversible bonding are available commercially. Examples that may be mentioned, without wishing to impose any restriction, are the Acronal 50D system from BASF and the Robond PS-8120 HV system from Rohm & Haas.

Where release liners are employed for the purposes of this invention that have been equipped with an adhesive layer and, preferably, with a reversibly adhesive layer, the carrier material may be either provided in a first step with the release material, by coating or printing, and then an adhesive layer may be applied, in order thus to give the desired release label material. It is also possible, and even preferred, to equip a reversibly adhesive label stock material, present for example in roll form and available commercially from various manufacturers, with release material by coating or printing in a subsequent step, in order thus to obtain the desired release label material.

It is advantageous to line the adhesive layer of the release label material with a liner. The release label material can then be slit and/or punched into desired formats, giving release labels in the desired form on this liner. Starting from this liner, further processing may be carried out in a favourable way, such as, for example, a dispensing operation in order to apply the release labels to a target substrate.

In terms of its format, the release label is preferably dimensioned, by trimming or punching, such that it is able to carry at least one security label and, where appropriate, two or more security labels, or all of the security labels of a security label set.

In one security label set which is particularly advantageous for the purposes of this invention, a security label is located on a plastic card. Plastic cards of this kind are known, in the form of guarantee cards, cheque cards, identification cards or chip cards. In the great majority of cases they are composed of PVC or else of acrylonitrile-butadiene-styrene (ABS) or else polycarbonate. They are often multi-layer laminates, which additionally may contain different functional elements, such as magnetic strips, signature fields, security features and/or chips (see, for example, W. Rankl, W. Effing, Handbuch der Chipkarten, C. Hanser Verlag, Munich, 1995, chapters 2 and 3).

To make up security label sets, security labels may be combined with one another in any desired way. For example, where security labels are needed for three different bonding positions, it is particularly advantageous to use a security label set that comprises these three requisite security labels. For its compilation it is conceivable, for example, to provide three rolls, A, B, and C, each with different series of labels. Label A from roll A is intended for subsequent bonding at position A on the product, label B from roll B, correspondingly, for position B, and label C from roll C for position C. The data and/or, with particular preference, at least parts of serial numbers on roll A may be the same or different. The same applies to data and/or, with particular preference, parts of serial numbers on roll B and/or roll C. One label each of A, B and C is employed for a product to be secured. After they have been produced, the labels A, B and C are processed in the form of the security label set of the invention: in other words, for example, are compiled on a plastic card which is then provided with security labels for the purpose of equipping the product that is to be secured.

One particularly preferred version of security label sets of the invention comprises a first security label A, which is located on a release label, which in turn is applied with reversible bonding to a plastic card, and also a second security label B, which is applied directly to the plastic card by means of a strongly adhering pressure-sensitive adhesive layer or of a heat-sealing adhesive.

In a further inventive embodiment at least one of the security labels of the security label set is present in such a way that it can be sewn into a product or attached firmly in another way. Without thereby restricting the embodiment, the label in question may be a pressure-sensitive adhesive label which is adhered on a tab. This tab may preferably be a textile tab, of the kind frequently encountered in clothing, textiles or other products produced principally by stitching. Examples of such also include leather articles such as bags, cases, shoes or other accessories.

It is also possible to manufacture the tab directly from the same material from which the security label is produced. Also conceivable is a laminate of one of the above-described materials of which the security label may be composed, and of a further film material, which is employed routinely for marking purposes in the textile industry sector. In such cases the tab material, which is advantageously free of adhesive agent on its top and bottom faces, is inserted in the security label set. The security label may be made up into the form, for example, of pouches, so that in this case as well, security against being lost is ensured.

Here as well it may be preferable for the tab material to be adapted to materials from which the article into which the tab is to be introduced, and which it is intended to protect in accordance with the invention, is manufactured. Without thereby restricting the choice of material, leather may be mentioned here as a preferred tab material for leather products.

If at least one of the security labels is in the form of above-described tabs, it is preferred in one embodiment of the invention for at least one other security label of the security label set to be firmly adhered on a plastic card. The reason for this is that it is necessary to ensure that the security label set remains assigned until it is introduced into the product. This can be done, for example, by means of joint packaging in a pouch. It is also conceivable, however, for the security labels to be assigned via their data content or, with particular preference, by at least part of their serial numbers.

As well as the above-described combination in the form of a set made up of tab label and label on plastic card, however, other labels or further labels on release liners, forming a set together with the tab, are in accordance with the invention. In this case a typical use is that the tab label is sewn or attached into a product and the at least one further security label is applied in the vicinity of the product, often also the product packaging, on application.

Besides the combinations described above, all further combinations of security labels are in accordance with the invention, it being immaterial whether they take the form of labels on release liners, on plastic card or on/as tabs. The number of security labels of which a security label set of this kind is composed is also not restricted in the context of this invention.

The advantage of security label sets of the invention is manifested primarily in the use thereof to secure any desired products against counterfeiting or grey market trading, and more particularly during the operation during which the product and also any further objects in the vicinity of the product, such as a pack, for example, are equipped with the security labels.

Another example for the use of a security label set of the invention is the marking of a product and of an associated guarantee card. It is nowadays common to sell articles in conjunction with a guarantee card which is intended to indicate the authenticity of the article. The background of the combination of the article with a guarantee card lies in the fact that, for example, the manufacturer will only accept the costs for a repair or a replacement, in a guarantee case, when the product is actually an original product. In order to be able to demonstrate this, the customer is requested, in the case of a complaint, to submit not only the product but also the guarantee card. In this case the customer card or guarantee card offers unambiguous assignment to the product to be protected, by virtue of the inventive marking with a security label of the security label set. Furthermore, however, they also permit the possibility of recording additional information, such as the address of the dealer or the purchase date, for example. It is increasingly important that information located on guarantee cards or customer cards can be entered via the Internet, in order thereby to obtain additional information concerning the product or to participate in customer loyalty programs, which frequently also take the form of a competition. This additional information can, in one inventive embodiment, also be utilized for the additional authentication of the card and hence, by the correlation of the labels of the security label set, the authentication of the product itself. The combination of a product and a guarantee card, and also possibly an additional pack, represent an application which can be served particularly advantageously through the use of security label sets according to the invention.

Above, examples have been given representatively of numerous applications in which more than one security label is employed per product. In the process of providing the product and, where appropriate, further objects associated with the product, such as a pack or a guarantee card, for example, the security label sets of the invention offer the advantage that the product i to be secured in a series of products to be secured, and, where appropriate, further objects associated with the product i, can be assigned a security label set, preferably a security label set i, that differs in—in particular—at least one part of a serial number from other security label sets which are envisaged for the securing of the entire product series. Staff or a machine can then apply the security labels, present as part of the security label set, at the correspondingly envisaged positions in and/or on the product i, and also, where appropriate, to further objects associated with the product i. In the case of the guarantee card, it can be used as a carrier material for the entire security label set. The guarantee card itself is already provided with the corresponding security label, while the others needed for the securing of the product are held ready on a release label for labelling. After labelling has been carried out, the release label material is passed on, for example, for recycling. In addition, these sets may also be assigned security labels on or as tabs.

The invention relates, furthermore, to a security label set system. A system of this kind features at least one security label set. The security label set features at least two security labels, which in turn are arranged indirectly or directly on a common backing. This backing is now designed as a release label; in other words, the labels can be parted from this release label without destruction, and can be used again. They are therefore arranged only temporarily, until the time of their actual use, on the release label, preferably by being adhered thereto. The release label in turn is arranged releasably on a liner in web form. Arranged on this liner there are preferably a multiplicity of different security label sets on release labels that are independent of one another. This system has the advantage that in a simple way it is possible simultaneously to dispatch a multiplicity of security label sets, and yet the assignment of the individual labels to one security label set remains intact. Any mixing-up of the security labels from different security label sets is effectively prevented. Furthermore, the individual security label sets can be applied later on, preferably adhered, for further propagation or processing, to objects, such as a carrier card, for example, more particularly a plastic card. Such an object may, where appropriate, have a further label, applied in a different way, more particularly by lamination onto a plastic card.

In a preferred embodiment the web-form liner is wound up as a roll, thereby significantly simplifying the handling and transport of a multiplicity of security label sets.

With further preference the design of the security label set is such that the web-form liner can be used again after the security label sets have been detached. This is possible more particularly when the release label is residuelessly detachable from the web-form liner. For this purpose the web-form liner preferably has a siliconized surface.

The security label sets arranged on the release label, and also the security labels themselves, are with further preference designed more particularly in accordance with the description above, to which reference is made in this respect.

Further details, features, aims and advantages of the present invention are elucidated in more detail below by reference to a drawing of one preferred exemplary embodiment.

### BRIEF DESCRIPTION OF THE SEVERAL VIEWS OF THE DRAWING(S)

FIG. 1 shows a plan view of a security label set of the invention.

### DETAILED DESCRIPTION OF THE INVENTION

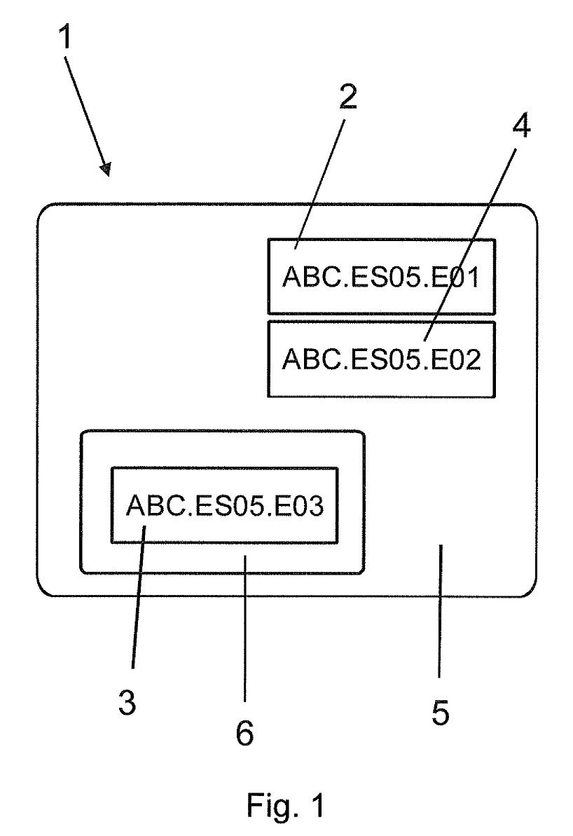

FIG. 1 shows a plan view of a security label set 1 of the invention. This security label set 1 has three security labels 2, 3, 4 and also a common backing 5. The security labels 2, 4 are arranged directly on the backing 5, while the security label 3 is arranged on a carrier 6, which in turn is arranged on the backing 5. Here, and preferably, the backing 5 takes the form of a plastic card. Carrier 6, in contrast, is a release liner, in other words a material that allows an adhered security label to be detached without destruction. For this purpose the carrier 6 has a siliconized surface. The security labels 2, 4 on the one hand and the security label 3 on the other hand are therefore arranged on substrates which differ from one another, so permitting a high degree of flexibility in the choice of the possible adhesives for the security labels.

In the present case the security label 2 is connected permanently to the backing 5; in other words, the label can be removed from the backing only with at least partial destruction. The security label here is laminated on the backing 5; an alternative, for example, is a permanent adhesive bond. In contrast, the security label 4 is adhered to the backing 5 with an adhesive which can be removed reversibly from the backing 5. Then, following removal from the backing 5, the security label 4 can be joined to a product in other ways. Here, and preferably, it is envisaged that the security label 4 is stitched to a textile.

In the present case the security label 3 is arranged partably on the carrier 6; here, specifically, it is bonded by a reversible adhesive material to the carrier 6. Moreover, the carrier 6 is also partable from the backing 5. As an alternative, provision may also be made for the security label 3 to be joined permanently to the carrier 6, more particularly by adhesive bonding therewith. The carrier 6 may in turn, again, be jointly and partably joined to the backing 5 with the security label 3. An embodiment of this kind is especially advantageous when the carrier 6 is a textile material which subsequently is to be stitched to the object to be secured.

The security labels 2, 3 and 4 each have an individualization in the form of a sequence of alphanumeric symbols. Alternatively or in addition it is also possible, for example, to use computer-generated holograms or other security features. In the present case the individualization comprises a product mark “ABC”, a mark for the label set “ES05”, and a mark of the individual label of the respective label set “E01”, “E02”, “E03”. Particularly important in this context is the correlation between the respective individualizations, in this case through the product marking and the marking of the label set, in order to rule out misuse of individual labels.

1. A security label set comprising
at least a first and a second security label,
a backing material common to the at least first and second security label,
wherein the at least first security label is arranged directly on the common backing material and the at least second security label is indirectly arranged on the common backing material.

2. The security label set according to claim 1, wherein the at least first and second security label is permanently arranged on the backing.

3. The security label set according to claim 1, wherein each security label is arranged releasably on the backing.

4. The security label set according to claim 1, wherein the indirectly arranged at least second security label is arranged on a carrier.

5. The security label set according to claim 4, wherein the at least second security label is joined permanently to the carrier and the carrier is releasably arranged on the backing.

6. The security label set according to claim 4, wherein the backing is a card.

7. The security label set according to claim 6, wherein the card is a plastic card.

8. The security label set according to claim 7, wherein the at least first security label is arranged by being adhered with a first adhesive to the common backing and the second security label is arranged by being adhered to the carrier with a second adhesive.

9. The security label set according to claim 8, wherein the at least first and second security label comprise individualization.

10. The security label set according to claim 9, wherein the individualization comprises a computer-generated hologram.

11. The security label set according to claim 9, wherein the individualization comprises a serial number or random number.

12. The security label set according to claim 9, wherein the individualization of the at least first and second security label are correlated with one another.

13. The security label set according to claim 11, wherein the at least first and second security labels have each serial numbers and wherein the serial numbers have partially identical numbers.

14. The security label set according to claim 9, wherein the individualization comprises common coding, in particular a running number, which indicates a logical connection between the at least first and second security label.

15. A security label set comprising
at least a first and a second security label,
a backing material common to the at least first and second security label,
wherein the at least first and second security label are each arranged on a carrier which is arranged on the common backing material and
wherein the carrier is a release label releasably arranged on a web-form liner.

16. The security label set system according to claim 15, wherein the web-form liner is wound up as a roll.

17. The security label set system according to claim 15, wherein the web-form liner is reusable after the security label set has been detached.

18. The security label set according to claim 2, wherein the permanent arrangement on the backing is accomplished by lamination.
